(19) United States
(12) Patent Application Publication
(10) Pub. No.: US 2013/0265537 A1
(43) Pub. Date: Oct. 10, 2013

(54) SAFETY EYEWEAR WITH LENS FRAME EYEWIRE HAVING RECTANGULAR CROSS-SECTION FOR IMPROVED LENS RETENTION

(71) Applicants: Charles Bottieri, Pomfret Center, CT (US); Michael Franz, Cumberland, RI (US); Patrick Mumford, Brooklyn, CT (US)

(72) Inventors: Charles Bottieri, Pomfret Center, CT (US); Michael Franz, Cumberland, RI (US); Patrick Mumford, Brooklyn, CT (US)

(73) Assignee: Honeywell International, Inc., Morristown, NJ (US)

(21) Appl. No.: 13/438,968

(22) Filed: Apr. 4, 2012

(51) Int. Cl. G02C 1/08

(52) U.S. Cl. 351/90

(57) ABSTRACT

A lens frame for retaining a prescription lens in safety eyewear includes an eyewire having a rectangular cross-sectional shape. The lens has a continuous channel in a peripheral edge thereof and is received within the lens frame with the eyewire being received within the channel in the lens and the front and rear surfaces of the eyewire continuously engaging the front and rear walls of the continuous channel in the lens. The rectangular cross-sectional shape of the eyewire allows the lens frame to flex when the lens is impacted.

### BACKGROUND

The present specification relates to an eyewear frame eyewire with a rectangular cross-section for retaining a lens, and further relates to an impact resistant eyewear frame including such an eyewire for prescription safety eyewear.

### SUMMARY

An exemplary embodiment of safety eyewear in accordance with the teachings of this disclosure includes left and right lens frames and a central bridge connecting the left and right lens frames. The left and right lens frames each include upper and lower eyewire portions extending from the central bridge outwardly and terminating in free ends which are configured and arranged with clamp blocks to form split frame clamps. A set screw extends through the clamp blocks to secure the free ends of the eyewires together.

In order to provide the safety eyewear and frames with flexibility in the plane of impact, the lens frames and central bridge are formed or stamped from sheet metal so that the upper and lower eyewire portions that engage the lens, each have a rectangular shaped cross-section and opposing front and rear surfaces perpendicular to the plane of impact.

The left and right lenses are conventional prescription lenses and each include a channel in a peripheral edge thereof. In assembly, the lenses are received respectively within the left and right lens frames with the upper and lower eyewire portions being received within the channels in the lenses and the front and rear surfaces of the eyewire portions continuously engaging the opposing front and rear walls of the channel.

The safety eyewear further includes left and right hinged temple bars extending rearwardly from hinges integrally formed with the clamp blocks at the free ends of the eyewires.

In use, the planar front and rear surfaces of the eyewires engage with corresponding planar surfaces within the groove and provide improved retention of the lenses and improved impact resistance in a direction of impact substantially perpendicular to those surfaces. In addition, because the entire frame structure is formed from a planar sheet of metal, the frame can flex without disengaging from the lenses.

Accordingly, an objective is to provide safety eyewear with improved lens retention.

Another objective is to provide safety eyewear having an impact performance that exceeds prevailing ANSI Z87.1 standards.

Yet another object is to provide a lens retention assembly where the engagement surfaces of the eyewire and the lens groove are both perpendicular to the plane of impact.

Other objects, features and advantages shall become apparent as the description thereof proceeds when considered in connection with the accompanying illustrative drawings.

### BRIEF DESCRIPTION OF THE DRAWING FIGURES

An exemplary embodiment will now be described further by way of example with reference to the following examples and figures, which are intended to be illustrative only and in no way limiting upon the scope of the disclosure.

FIG. 1 is a front view of an exemplary safety eyewear constructed in accordance with the teachings of the present disclosure;

FIG. 2 is a side view thereof;

FIG. 3 is a top view thereof;

FIG. 4 is a cross-sectional view of the eyewire and lens taken along line 4-4 of FIG. 1;

FIG. 5 is an enlarged sectional view of the eyewire and lens in FIGS. 4; and

FIG. 6 is an enlarged view of the hinge assembly.

### DETAILED DESCRIPTION OF AN EXEMPLARY EMBODIMENT

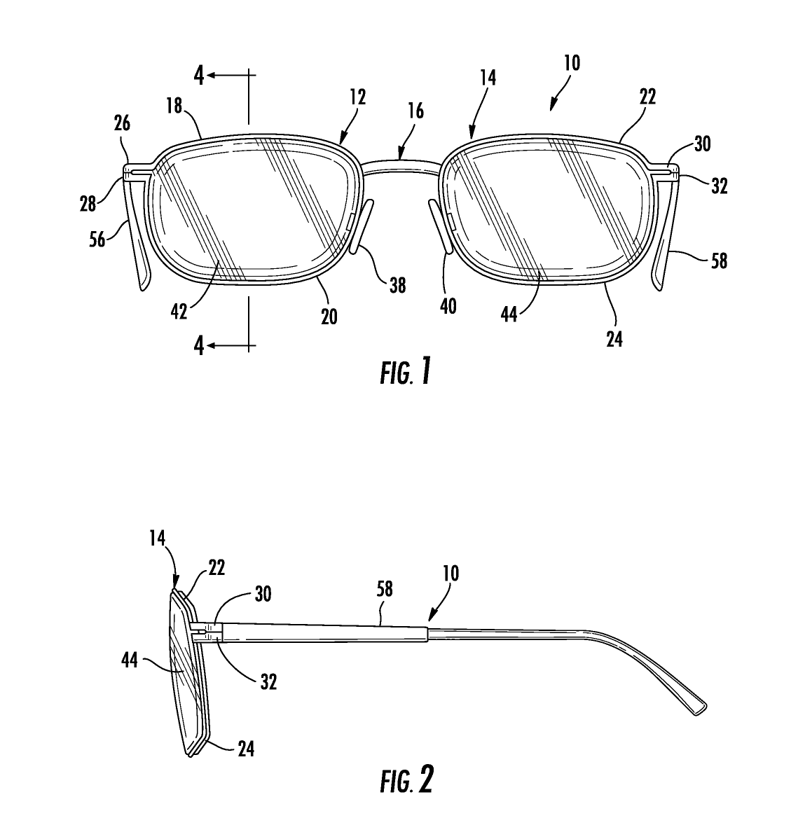

An exemplary embodiment of safety eyewear in accordance with the teachings of this disclosure is generally indicated at 10 in FIGS. 1-6. The safety eyewear 10 includes left and right lens frames 12,14 and a central bridge 16 connecting the left and right lens frames 12,14. The left and right lens frames 12,14 each include upper and lower eyewire portions 18,20 and 22,24 extending from the central bridge 16 outwardly and terminating in free ends 26,28 and 30,32 which are configured and arranged with clamp blocks 26A,28A (see FIG. 6) (see also FIG. 5 for the upper clamp block 30A of the right lens frame 14) to form conventional split frame clamps (See FIG. 6). Note that only one full pair of clamp blocks 26A,28A is illustrated in FIG. 6, however, it is to be understood that the opposing pair is identical. Set screws 34,36 extend through the respective pairs of clamp blocks 26A, 28A to secure the free ends 26,28 and 30,32 of the eyewires 18,20 and together 22,24. (Noted again that lower clamp block on free end 32 is not illustrated.)

The central bridge 16 further includes with nose pads 38, 40 which are conventional in the art.

The safety eyewear 10 further includes left and right lenses 42, 44 which can be zero power lenses or conventional prescription lenses. Each lens 42,44 includes a continuous channel 46 extending around the peripheral edge 48 thereof. Note that only one lens 42 and its channel 46 is illustrated in cross-section. The channel in lens 44 is identical.

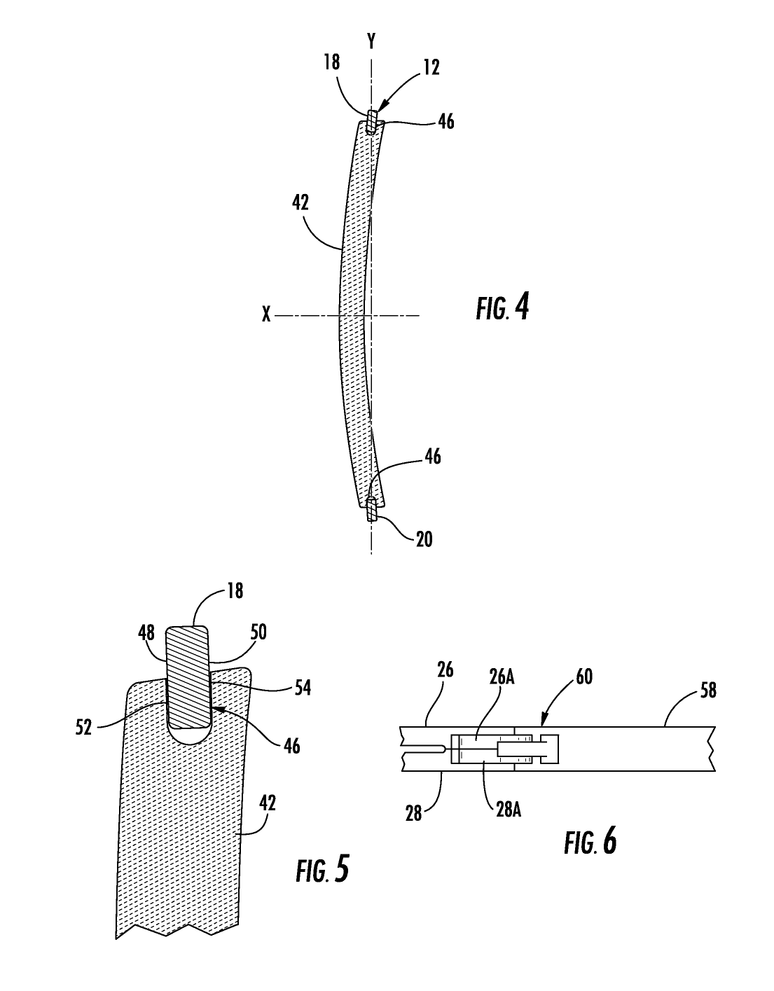

In order to provide the safety eyewear 10 and lens frames 12,14 with flexibility in a plane of impact (See plane X—FIG. 4), the lens frames 12,14 and central bridge 16 are formed or stamped from sheet metal so that the upper and lower eyewire portions 18,20 and 22,24 that engage the lens 42,44, each have a rectangular shaped cross-section (See FIGS. 4 and 5) and opposing front and rear surfaces 48, 50 perpendicular to the plane of impact X.

While the exemplary embodiment illustrates that the lens frames 12,14 and central bridge 16 are integrally formed from sheet metal, it is to be understood that the lens frames 12,14 could be individually formed from sheet metal and that the central bridge 16 could be soldered to the lens frames 12,14 without departing form the teachings herein. It is also contemplated that the novel concepts herein could be utilized in embodiments including only a single lens frame, such as a goggle or other monocular eyewear.

In assembly, the lenses 42,44 are received respectively within the left and right lens frames 12,14 with the upper and lower eyewire portions 18,20 and 22,24 being seated within the channels 46 in the lenses 42,44. Referring to FIGS. 4 and 5, it can be seen that the front and rear surfaces 48,50 of the eyewire portions 18,20 and 22,24 snugly engage the opposing front and rear walls 52,54 of the channels 46 to retain the lenses 42,44. It is also noted that the eyewires 18,20 and 22,24 continuously engage the channels 46 around the entire circumferential edge of the lenses 42,44.

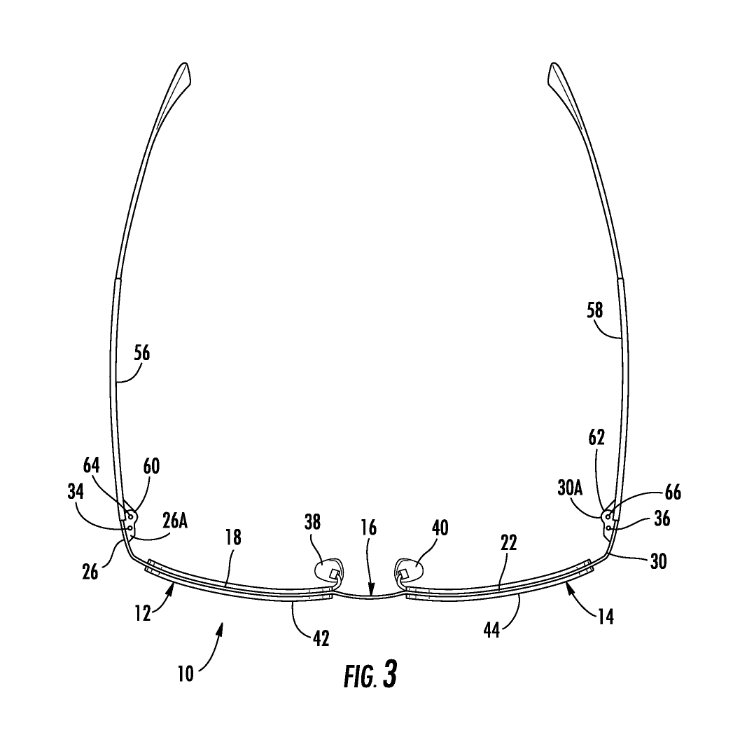

The safety eyewear further includes left and right hinged temple bars 56,58 extending rearwardly from hinges 60,62 integrally formed with the clamp blocks 26A, 28A, 30A at the free ends 26,28 and 30,32 of the eyewires 18,20 and 22,24 and the temple bars 56,58. Hinge screws 64,66 can best be seen in the top view in FIG. 3.

In operation, the planar front and rear surfaces 48,50 of the eyewires 18,20 and 22,24 engage with corresponding planar surfaces 52,54 within the groove 46 and provide improved retention of the lenses 42,44 and improved impact resistance in a direction of impact (see plane of impact X—FIG. 4) substantially perpendicular to those surfaces (see retention plane Y—FIG. 4). In addition, because the entire frame structure is formed from a planar sheet of metal, the frame can flex without disengaging from the lenses 42,44.

For these reasons, the impact resistant frame and eyewire as disclosed herein is believed to represent a significant advancement in the art which has substantial commercial merit.

While there is shown and described herein certain specific structure embodying an illustrative example, it will be manifest to those skilled in the art that various modifications and rearrangements of the parts may be made without departing from the spirit and scope of the underlying concept and that the same is not limited to the particular forms herein shown and described except insofar as indicated by the scope of the appended claims.

What is claimed is:

1. A lens frame for retaining a lens, said lens having a continuous channel in a peripheral edge thereof, said lens frame comprising a continuous eyewire having a rectangular shaped cross-section with front and rear surfaces, said lens being received within said lens frame with said continuous eyewire being received within said channel in said lens and said front and rear surfaces of said eyewire continuously engaging said front and rear walls of said continuous channel in said lens.

2. The lens frame of claim 1 wherein said eyewire is integrally formed from a sheet of metal.

3. The lens frame of claim 1 wherein said eyewire includes split frame clamps.

4. The lens frame of claim 2 wherein said eyewire includes split frame clamps.

5. The lens frame of claim 1 wherein said front and rear surfaces of said eyewire and said front and rear walls of said groove in said lens extend in a plane which is substantially perpendicular to a plane of impact.

6. The lens frame of claim 2 wherein said front and rear surfaces of said eyewire and said front and rear walls of said groove in said lens extend in a plane which is substantially perpendicular to a plane of impact.

7. The lens frame of claim 3 wherein said front and rear surfaces of said eyewire and said front and rear walls of said groove in said lens extend in a plane which is substantially perpendicular to a plane of impact.

8. The lens frame of claim 4 wherein said front and rear surfaces of said eyewire and said front and rear walls of said groove in said lens extend in a plane which is substantially perpendicular to a plane of impact.

9. Safety eyewear comprising:
left and right lens frames;
a central bridge connecting said left and right lens frames;
said left and right lens frames each including eyewire portions extending from said central bridge and terminating in free ends which are configured and arranged to form split frame clamps;
said eyewire portions each having a rectangular shaped cross-section with front and rear surfaces; and
left and right lenses each including a channel in a peripheral edge thereof, said channel having a front wall and a rear wall,
said left and right lenses received respectively within said left and right lens frames with said eyewire portions being received within said channels in said lenses and said front and rear surfaces of said eyewire portions engaging said front and rear walls of said channel.

10. The safety eyewear of claim 9 wherein said front and rear surfaces of said eyewire portions and said front and rear walls of said grooves in said lenses extend in a plane which is substantially perpendicular to a plane of impact.

11. The safety eyewear of claim 9 wherein said left and right lens frames and said central bridge are integrally formed from a sheet of metal.

12. The safety eyewear of claim 10 wherein said left and right lens frames and said central bridge are integrally formed from a sheet of metal.

13. Safety eyewear comprising:
left and right lens frames;
a central bridge connecting said left and right lens frames;
said left and right lens frames each including upper and lower eyewire portions extending from said central bridge outwardly and terminating in free ends which are configured and arranged to form split frame clamps;
said upper and lower eyewire portions each having a rectangular shaped cross-section with front and rear surfaces; and
left and right lenses each including a channel in a peripheral edge thereof, said channel having a front wall and a rear wall,
said left and right lenses received respectively within said left and right lens frames with said upper and lower eyewire portions being received within said channels in said lenses and said front and rear surfaces of said eyewire portions substantially continuously engaging said front and rear walls of said channel.

14. The safety eyewear of claim 13 further including left and right temple bars extending rearwardly from said lens frames.

15. The safety eyewear of claim 13 wherein said front and rear surfaces of said eyewire portions and said front and rear walls of said grooves in said lenses extend in a plane which is substantially perpendicular to a plane of impact.

16. The safety eyewear of claim 14 wherein said front and rear surfaces of said eyewire portions and said front and rear walls of said grooves in said lenses extend in a plane which is substantially perpendicular to a plane of impact.

17. The safety eyewear of claim 13 wherein said left and right lens frames and said central bridge are integrally formed from a sheet of metal.

18. The safety eyewear of claim 14 wherein said left and right lens frames and said central bridge are integrally formed from a sheet of metal.

19. The safety eyewear of claim 15 wherein said left and right lens frames and said central bridge are integrally formed from a sheet of metal.

20. The safety eyewear of claim 16 wherein said left and right lens frames and said central bridge are integrally formed from a sheet of metal.
